(19) United States
(12) Patent Application Publication
(10) Pub. No.: US 2010/0328713 A1
(43) Pub. Date: Dec. 30, 2010

(54) MODULAR TRANSACTION PRINTER

(75) Inventors: John J. Hilbert, Torrance, CA (US); Eric James Meyerhofer, Pasadena, CA (US)

Correspondence Address: FITZPATRICK CELLA HARPER & SCINTO, 1290 Avenue of the Americas, NEW YORK, NY, 10104-3800, US

(73) Assignee: FUTURELOGIC, INC., Glendale, CA (US)

(21) Appl. No.: 12/741,164

(22) PCT Filed: Nov. 6, 2008
(86) PCT No.: PCT/US08/82676

§ 371 Date: Sep. 13, 2010

Related U.S. Application Data
(60) Provisional application No. 60/985,778, filed on Nov. 6, 2007.

(51) Int. Cl. G06F 3/12

(52) U.S. Cl. 358/1.15

(57) ABSTRACT

A modular transaction printer for generating financial transaction records such as gaming vouchers and coupons. The printer uses self-contained expansion modules that plug into a printer port for easy in-field upgradeability. The printer includes a mechanical package to allow modules to be inserted from the printer exterior, an electrical interface to allow modules to communicate with the printer electronics, and a latching mechanism to secure the modules to the printer for easy connect and disconnect from the printer body. Each module includes dynamic memory, non-volatile memory, processor circuitry necessary to accomplish a port or an interface with an outside host device, and a standard bus style interface method for interchangeable expansion modules. By using interchangeable expansion modules, a printer can be configured as a base or basic model. Then depending on configuration requirements, the interchangeable modules can be securely attached to the printer.

CROSS-REFERENCE TO RELATED APPLICATION(S)

The present application claims the benefit of U.S. Provisional Patent Application No. 60/985,778, filed Nov. 6, 2007, and is related to PCT Application PCT/US07/78319 entitled “MODULAR GAMING TRANSACTION PRINTER”, filed Sep. 27, 2007, which claims the benefit of U.S. Provisional Patent Application No. 60/825,372, filed Sep. 12, 2006, each of which is hereby incorporated by reference as if stated in full herein.

### BACKGROUND OF THE INVENTION

1. Field of the Invention

This invention relates to gaming and gaming printers, more specifically to a modular transaction printer for generating financial transaction records such as gaming vouchers and coupons. The printer uses expansion modules which are self-contained devices to allow for the modular expansion and open system architecture where an expansion module plugs into a port of the printer for easy in-field upgradeability.

2. Background

The gaming machine manufacturing industry provides a variety of gaming machines for the amusement of gambling players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers have provided cash-less enabled games to the market for the last five year, and there now exists a broad population of such games in the casino industry. Cash-less enabled games are so named due to the fact that they can conduct their player's financial exchange with a mixture of traditional paper and coin currency and vouchers redeemable for cash or game credits.

Two pieces of equipment included in a cash-less enabled game is a printer to produce the vouchers, and a bill acceptor that supports automatic reading of the vouchers. In a cash-less enabled gaming system, when a player cashes out, the game is signaled and depending on the size of the pay out, the game can either present coins in the traditional method of a slot machine, or the game can cause the printer which is installed in such a machine to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

Over time, cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers which may be used to print coupons and promotions for the captive player audiences.

### SUMMARY OF THE INVENTION

The present invention identifies a modular transaction printer for generating financial transaction records such as gaming vouchers and coupons. The printer uses expansion modules which are self-contained devices to allow for the modular expansion and open system architecture where an expansion module plugs into a port of the printer for easy in-field upgradeability.

In one aspect of the invention, a modular transaction printer includes one or more expansion modules.

In another aspect of the invention, a modular transaction printer includes an expansion bus in addition to the main controller of the printer where the expansion bus is generic in nature to allow for the future expansion of the printer's main controller functionality.

In another aspect of the invention, a modular transaction printer includes one or more expansion bays or ports to which an expansion module connects or plugs in where one expansion bay or port is used for the future expansion of the printer's main controller functionality and one expansion bay or port is used for the printer resources.

In another aspect of the invention, an expansion module is a self-contained device which is prepackaged with the necessary data, among others, to perform certain functions, such as promotional printing.

In another aspect of the invention, an expansion module is a self-contained device including any two or more of the following: circuit board, controller, memory, logic circuitry, authentication memory, data or logic, a port connector, an enclosure, a latching mechanism, and user indicators.

In another aspect of the invention, an expansion module is hot swappable in that the printer need not be powered down to add or remove an expansion module.

In another aspect of the invention, an expansion module includes the necessary data and/or logic to identify the expansion module as an authentic module suitable for use in the printer.

In another aspect of the invention, a modular transaction printer includes the means to permit the snap-in retention or snap mount of one or more boards and/or components to ease servicing and/or replacement of boards and/or components.

In another aspect of the invention, a modular transaction printer includes a processor, memory, firmware, algorithms, programming logic, print mechanism, a storage device, a printer main controller, and more communication interfaces such as a communication port or driver.

In another aspect of the invention, an expansion module includes the necessary data and/or logic to upgrade the firmware of the main controller and/or module processor.

In another aspect of the invention, a module processor interfaces and connects with another port and the printer thereby allowing communication and data exchange with one or more host systems.

### BRIEF DESCRIPTION OF THE DRAWINGS

These and other features, aspects, and advantages of the present invention will become better understood with regard to the following description, accompanying drawings and appendix where:

These and other features, aspects, and advantages of the present invention will become better understood with regard to the following description and accompanying drawings where:

FIG. 1 is a perspective view of a modular transaction printer and components thereof in accordance with an exemplary embodiment of the present invention;

FIG. 2 is a block diagram of a modular transaction printer in accordance with an exemplary embodiment of the present invention;

FIG. 3 is an illustration of the expansion bays or ports of a modular transaction printer in accordance with an exemplary embodiment of the present invention;

FIG. 4 is an illustration of the expansion bus of a modular transaction printer in accordance with an exemplary embodiment of the present invention;

FIG. 5 is an illustration of an expansion bay or port for printer resources in accordance with an exemplary embodiment of the present invention;

FIG. 5b is another illustration of an expansion bay or port for printer resources in accordance with an exemplary embodiment of the present invention;

FIG. 6a is an exploded view of an expansion module for a modular transaction printer in accordance with an exemplary embodiment of the present invention;

FIG. 6b is a partial side view of a modular transaction printer and expansion bays or ports and expansion modules in accordance with an exemplary embodiment of the present invention;

FIG. 7 is a block diagram of a modular transaction printer and expansion modules in accordance with an exemplary embodiment of the present invention;

FIG. 8 is a flow chart of a firmware upgrade process using an expansion module in accordance with an exemplary embodiment of the present invention; and

APPENDIX A is a list of definitions of terms as used herein.

Identically labeled elements appearing in different ones of the figures refer to the same elements but may not be referenced in the description for all figures.

### LIST OF TERMS

For the purposes of this document the following definitions apply:
“Gaming Establishment”—A casino in the traditional sense, or other place where gambling takes place.
“Gaming Machine”, “Game Machine”, “Game”—A slot machine, gaming machine, or game table in a gaming establishment.
“Gaming Voucher”—A media, such as paper, containing sufficient information to identify at a minimum, an amount of money and a validation number use to authenticate the transaction. Used for the cashless exchange of credit between games.
“Promotional Ticket”, “Promotional Coupon”—A media, such as paper, containing sufficient information to identify at a minimum, a promotional offer made to a patron. These include coupons, promotional messages, player messages, free play vouchers, bonus tickets, etc.
“Promotional System”—A system responsible for issuing promotional coupons from the game.
“Main controller”—A processor, comprised of at least a CPU, its memory and any associated logic located within the main body of the printer. The Main controller is primarily responsible for printing vouchers and interfacing with the game.
“Module Processor”—A processor, comprised of at least a CPU, its memory and any associated logic located within an expansion module. The Module Processor is responsible for processing print jobs, such as vouchers, Promotional Tickets, and for interfacing to either the game or other external systems.

### DETAILED DESCRIPTION OF THE INVENTION

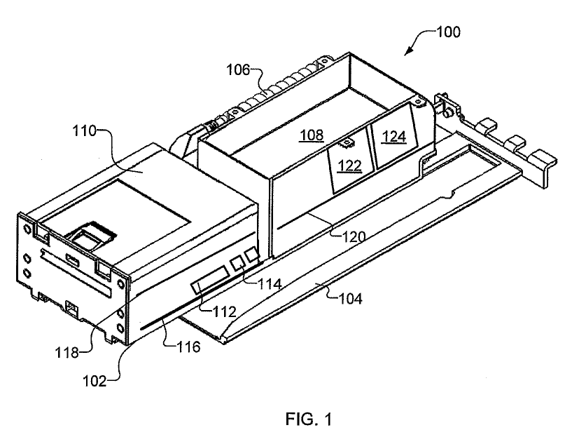

FIG. 1 is a perspective view of a modular transaction printer and components thereof in accordance with an exemplary embodiment of the present invention.

A modular transaction printer for generating financial transaction records such as gaming vouchers and coupons uses expansion modules which are self-contained devices to allow for the modular expansion and open system architecture where an expansion module plugs into a port of the printer for easy in-field upgradeability. The expansion modules may be printer resource expansion modules that are used to either access or extend the resources of the printer or they may be functional expansion modules that are used to expand the functionality of a processor of the printer.

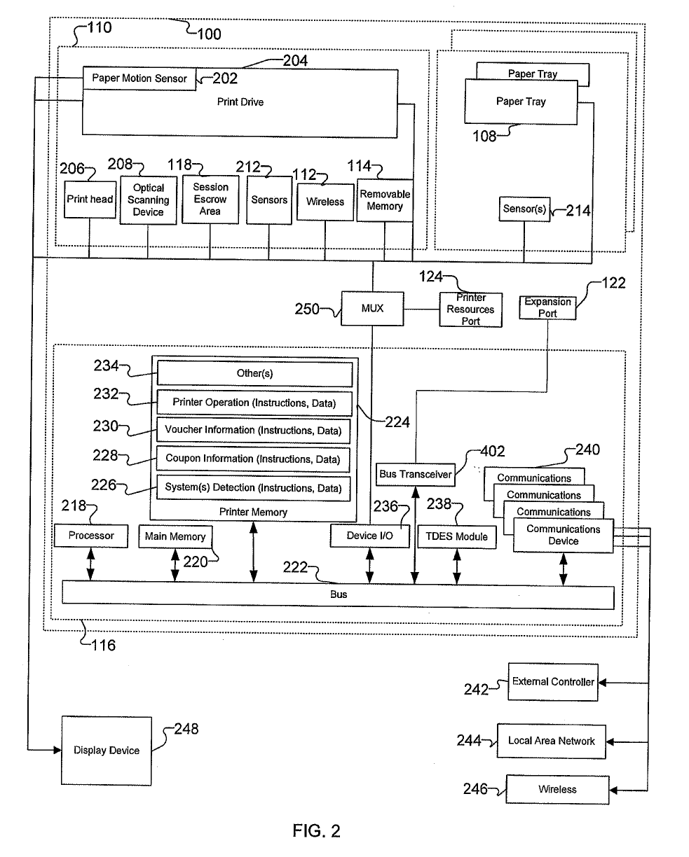

As illustrated, the modular transaction printer 100 includes a mobile module 102 slidably and removably connected to a stationary module 104. In one embodiment of a modular transaction printer in accordance with the present invention, a coiled electrical cable 106 is used to connect the mobile module to the stationary module. The coiled electrical cable includes power, communication, and other signals required for the operation of the mobile module and the stationary module included in the modular transaction printer. As the coiled electrical cable, similar to a coiled cable connecting a telephone handset to its base, is designed to be flexible, the coiled cable does not experience excessive wear during repeated accesses by an attendant for maintenance and replenishing a supply of blank vouchers held in the storage area or paper tray 108 of the printer. A more detailed discussion of the printer and components thereof is presented in U.S. Patent Application entitled “GAMING MACHINE PRINTER” published as U.S. Patent Application Publication Number 2004/0132529, and in U.S. Patent Application entitled “GAMING MACHINE PRINTER” published as U.S. Patent Application Publication Number 2005/0109810, the contents of each of which are hereby incorporated by reference as if stated herein in full as well as later disclosed in FIG. 2.

The mobile module 102 of the printer 100 can include two primary components: a print module 110 and one or more paper trays 108. The print module houses the electronic components and other components of a modular transaction printer. These components include the main electronics board for mounting a main controller 116, print head 206 (of FIG. 2), session escrow area 118, one or more wireless device interfaces 112, and one or more removable memory device interfaces 114, among others.

The print head 206 (of FIG. 2) includes the means by which a modular transaction printer 100 prints vouchers and/or promotional coupons.

The session escrow area 118 serves as a means where, after one or more media is printed by a modular transaction printer 100, such media is held in escrow while waiting for other media to be printed. The printing and storing of media in a session escrow area can occur simultaneously with other functions or processes of the printer such as interfacing and communicating with other devices. The session escrow area can be accessed externally to the printer. For example, in one embodiment, a modular transaction printer processes data related to one or more promotional coupons and print such coupons at the beginning of a player session such as after the game connected to the printer transmits to the printer that a cash-in signal was received. Each promotional coupon is stored in the session escrow area until the game transmits to the printer that a cashout signal was received, after which the printer prints a voucher and presents to a player the voucher and the one or more promotional coupons from the session escrow area.

In another embodiment, the printer 100 processes and prints one or more promotional coupons anytime during a player session and stores each coupon in the session escrow area 118. Again, after the connected game transmits to the printer that a cashout signal was received, the printer prints a voucher and presents to a player the voucher and each coupon stored in the session escrow area.

In another embodiment, the printing and storing of media in a session escrow area 118 occurs simultaneously with other functions or processes of the printer 100 such as interfacing and communicating with other devices.

A wireless device interface 112 serves as the means to interface and communicate with other devices using wireless technology where such interfacing occurs simultaneously with other functions or processes of the printer 100 such as printing. Wireless device technology includes Bluetooth, WiFi, wireless USB, among others. A wireless device includes any wireless device such as PDAs, personal computers, local or wide area networks, handheld devices, routers, gaming machines such as a slot machine, vending machines or kiosks, among others. In one embodiment, the printer includes one or more wireless device interfaces.

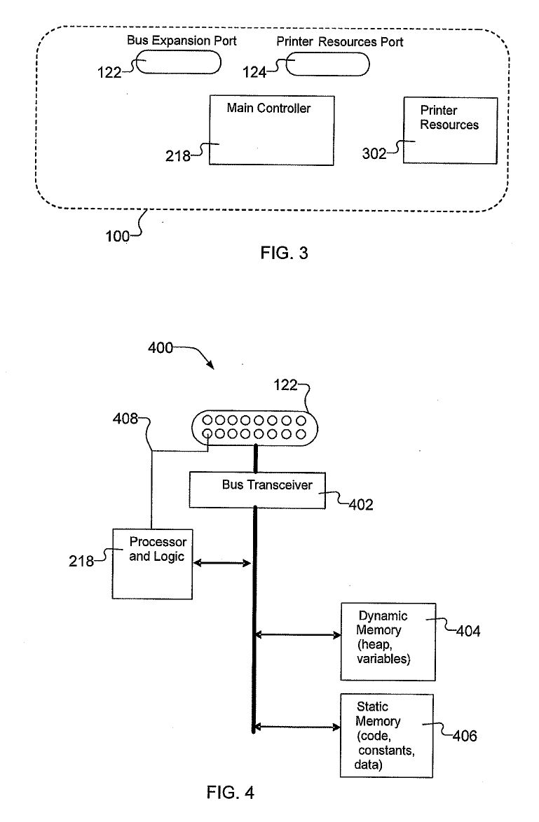

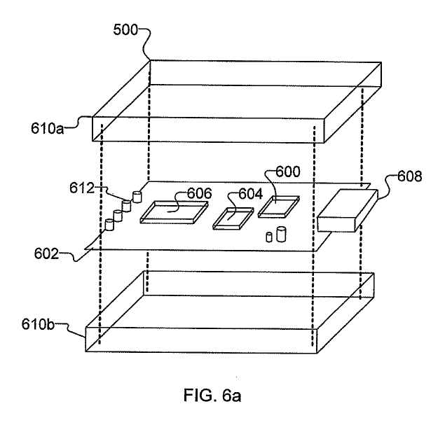

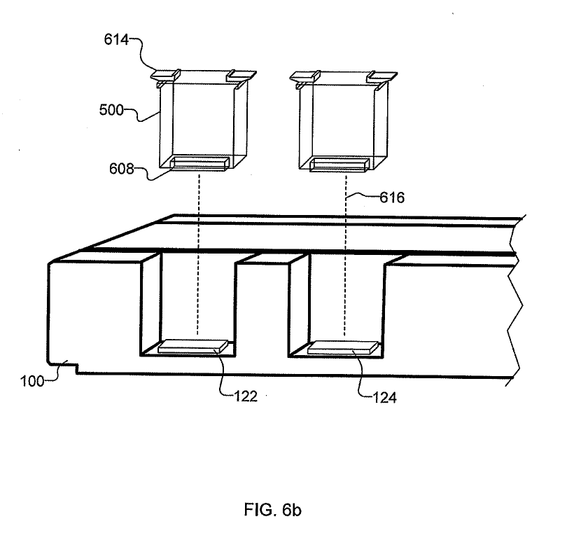

A removable memory device interface 114 interfaces with one or more removable memory devices such as an expansion module 500 (of FIG. 5a), memory stick or FLASH stick, among others. Each removable memory device is internal or external to the printer 100. The interface to such devices includes a USB interface. In one embodiment, the printer includes one or more removable memory device interfaces 114 such as expansion bays or ports each to which an expansion module 500 (of FIG. 5a) connects or plugs in where one expansion bay or port 122 allows for the future expansion of the printer's main controller 218 (of FIG. 2) functionality and one expansion bay or port 124 is used for the printer resources 302 (of FIG. 3). Further detail on an expansion bay or port is disclosed later in FIG. 3, FIG. 5a, FIG. 5b, and FIG. 6a as well as throughout this specification. Further detail on an expansion module is disclosed in FIG. 6a and FIG. 6b as well as throughout this specification.

In another embodiment, the contents of a removable memory device 114 includes promotional coupon data such as graphics and templates, trigger metrics, promotional campaigns as well as language and font packs, and firmware to upload, among others.

One or more paper trays 108 hold media for use with promotional coupons and vouchers. One tray is used for the promotional coupon media and another tray for gaming voucher media. In another embodiment, one paper tray holds media used for printing promotional coupons and gaming vouchers.

The media for use with the modular transaction printer 100 can be color media which allows information printed on media to print in color, grayscale media which allows information printed on media to print in grayscale, or the one color media currently used in gaming and vending applications to print gaming vouchers or promotional coupons.

In another embodiment, one paper tray 108 holds scrap printed media. For example, instead of presenting to a player a gaming voucher that was voided by the printer 100, the printer, after voiding the voucher, returns such voucher to another paper tray of the printer.

In another embodiment, a paper tray 108 includes two separate areas 120 where one area holds promotional coupon media and the other holds voucher media.

The modular transaction printer 100 includes one or more expansion bays or ports each to which an expansion module 500 (of FIG. 5a) connects or plugs in where one expansion bay or port 122 allows for the future expansion of the printer's main controller 116 (of FIG. 2) functionality and one expansion bay or port 124 is used for the printer resources 302 (of FIG. 3). Future detail on an expansion bay or port is disclosed later in FIG. 3, FIG. 5a, FIG. 5b, and FIG. 6a as well as throughout the specification. Further detail on an expansion module is disclosed in FIG. 6a and FIG. 6b as well as throughout this specification.

FIG. 2 is a block diagram of a modular transaction printer in accordance with an exemplary embodiment of the present invention. Any one or more components shown in FIG. 2 may be optional.

The print module 110 includes a print drive 204 that moves media such as a gaming voucher or promotional coupon through the print module. The print drive is reversible such that media may be fed through the print module in more than one direction by the print drive. The print drive includes a paper motion sensor 202 for sensing media movement within the print drive. A more detailed discussion of printer media motion detection within a printer 100 is presented in U.S. Patent Application entitled “PAPER MOTION DETECTOR IN A GAMING MACHINE”, filed Aug. 12, 2003, now U.S. Pat. No. 7,347,782, the contents of which are hereby incorporated by reference as if stated herein in full.

The print module 110 further includes a print head 206 for writing indicia to media such as a gaming voucher or promotional coupon. The print module further includes an optical scanning device 208 for scanning the indicia printed onto media. A modular transaction printer main controller 116, hosted by the data processing system, uses the optical scanning device as an interface to receive voucher scan signals from an optical scanning device.

The print module 110 further includes a session escrow area 118 as previously described in FIG. 1.

The print module 110 further includes a sensor interface 212 connected to the processor 218 via the system bus 222. The gaming machine printer main controller, hosted by the data processing system, uses the sensor interface to receive sensor signals from various components of a printer 100 as previously described.

The print module 110 further includes one or more interfaces to wireless technology 112 as previously described in FIG. 1. The print module further includes one or more interfaces to removable memory devices 114 as previously described in FIG. 1.

The print module 110 is removably and electronically connected to the printer main controller 116 and removably and mechanically connected to one or more paper trays 108.

In operation, the print module 110 receives printer control signals from the printer main controller 116. In response to the printer control signals, the print module thermally prints on the media, under the control of the printer main controller.

The one or more paper trays 108 store media and provide the media to the printer module 110 on command from the printer main controller 116. In operation, the paper tray receives media control signals from the printer main controller. In response to the control signals, the paper tray feeds media to the printer 100. The paper tray also includes one or more sensors 214 which detect media stored in a paper tray.

The printer main controller 116 includes a processor 218 connected to a main memory 220 by a system bus 222. The printer main controller also includes a printer memory 224 connected to the processor by the system bus, the printer memory including the firmware for system detection 226, printer operation 232, voucher information 230, coupon information 228, and others 234.

The printer memory 224, either internal and/or external, consists of such common devices as RAM, EPROM, EEPROM, FLASH Chips, magnetic storage devices such as floppy or hard drivers, Flash Sticks and other storage media commonly used in the computer industry. The printer memory includes one or more memory sections that can be independently addressed for both content read and content write operations. A printer operation section 232 is included for storage of programming instruction codes and printer data used by the processor 218 to operate the printer 100. The execution of these codes determines the conditions under which voucher information, including voucher generation instructions and voucher data included in a voucher information section 230 are utilized to generate a gaming voucher. A coupon information section 228 included in the printer memory holds coupon generation instructions and coupon data used by the printer to generate a promotional coupon.

The system detection section 226 of the printer memory 224 is used by the printer 100 to configure itself after power up to perform gaming voucher printing, promotional coupon printing, or a combination thereof based on one or more systems detected. The system detection section also detects whether the printer is operating in a cashless enabled game or gaming table within a gaming system, a promotional system, or a combination thereof without recycling the power to the printer. Upon detection of a gaming system, the system detection section of the printer memory then interacts with the printer operation section 232 and voucher information section 230 of the printer memory to allow the printer to generate gaming vouchers. Upon detection of a promotional system, the system detection section of the printer memory then interacts with the printer operation section and coupon information section 228 of the printer memory to allow the printer to generate promotional coupons. Upon detection of dual systems of both gaming and promotional systems, the system detection section of the printer memory then interacts with the printer operation section, the voucher information section, and the coupon information section of the printer memory to allow the printer to function with a cashless enabled game or gaming table to generate gaming vouchers and, if necessary or available, promotional coupons.

Generally, the contents of the printer operation section 232 are not changed frequently. The contents of the voucher information section 230 describe the format of the information that is printed on a gaming voucher. Contents of the voucher information section are changed rarely. The coupon information section 228 includes the data that describes the format of the information that is printed on a promotional coupon. The contents of the coupon information section are changed frequently. The contents of system detection section 226 are changed rarely.

The partitioning of the memory 224 into separate code and data sections allows separate signatures to be maintained for each section. A signature, as an example the mathematical formula, can be generated for the memory content of a first section, such as the printer operation content 232, independently of all other memory sections. A second signature, again as an example of a mathematical formula, can be generated for a second memory section, such as the voucher data section 230, independently of all other memory sections. A third signature, again as an example of a mathematical formula, can be generated on a third memory section, such as the coupon section 228, independently of all other memory sections. The signatures provide an identifier that is statistically unique in describing the contents of each memory section. A fourth signature, again as an example of a mathematical formula, can be generated on a fourth memory section, such as the systems detection section 226, independently of all other memory sections. In addition, a signature can be generated for all the memory sections combined.

In practical use, the sectioned printer memory 224 allows the contents of the second section and/or third section to be viewed individually and separately from the contents of the first section. The mathematical formula used to generate the statistically unique identifier or signature of the printer has not changes, through alteration of the programming instruction codes or by other means.

The second section and third section can contain the content of the printed image of a gaming voucher and a promotional coupon, respectively. For example, in the case of a promotional coupon, a gaming establishment operator may want to change the image and contents of the promotional coupon frequently. In this case, the gaming establishment then changes just the third section of memory including the coupon data 228 without disturbing the first section of memory. The conditions that cause the gaming voucher and/or promotional coupon to be printed are controlled by the cashless enabled game or gaming table in accordance with the programming instruction codes and the voucher and/or coupon data.

The printer main controller 116 also includes an Input/Output (I/O) device 236 connected to the processor 218 by the system bus 222. The I/O device is used by the printer main controller to transmit control signals to the print module 110 and each paper tray 108. The I/O device also is used by the printer main controller to receive security feature and status signals from the print module and each paper tray.

The control signals may be routed through a multiplexer 150 that is operatively connected to one or more printer resources ports 124. The printer resource port allows the connection of an expansion module (not shown) that can access printer resources in the print module 110 as described herein.

One or more communications devices 240 are connected to the system bus 222 for use by the printer main controller 116 to communicate with a cashless gaming system host or a game controller. The printer main controller uses the communication devices to receive commands, program instructions, and other information from the external devices. In addition, the printer main controller uses the communication devices to transmit printer status information to the external devices. Other communication devices also can be used by the printer main controller to connect in a secure fashion over a local area network 244 either a hard link or wireless or both for administrative or other purposes.

Additional communication devices 240 and channels are provided for communication with other peripheral devices as needed. For example, one communication device is provided with a local communications port, accessible from an exterior of a gaming machine hosting the printer 100 that a technician uses to communicate with the printer main controller 116 during servicing using an external controller 242. The external controller can communicate with the printer main controller using Bluetooth, WiFi, infrared link, other short-range wireless 246 communication link, or a hard link 244 with an external connector in a secure manner.

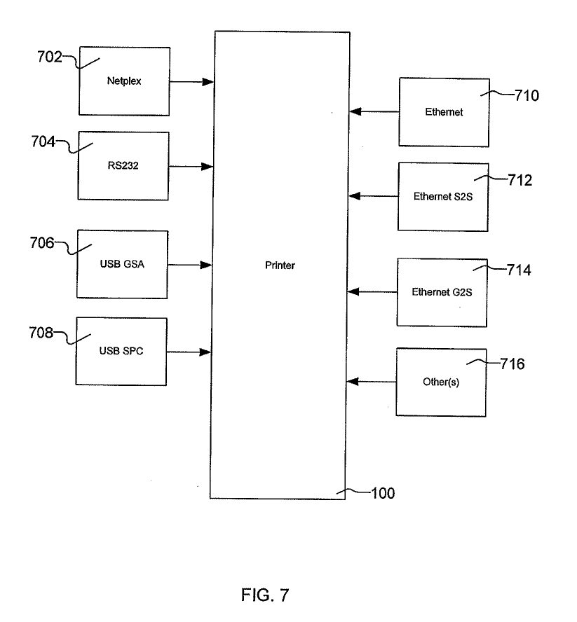

In another example, an expansion module 500 (of FIG. 5a) connects to the printer 100 to interface and connect to another protocol or system such as USB GSA. Additional details are disclosed in FIG. 7.

The processor 218 further is connected to an encryption/decryption module 238 that encrypts and decrypts messages encoded using an encryption standard. This enables the printer main controller 116 to engage in secure transactions with external devices. The processor accesses the display device 248 either as a component through the bus 222 as shown or as an external device through a communications device 240 using a high level communications protocol. In addition, the printer main controller also includes program instructions to perform encryption/decryption services as well.

The processor 218 further is connected to a display device 248 to display printer status information and/or media information. The processor accesses the display device either as a component through the I/O device 236 or as an external device through a communications device 240.

The printer main controller 116 is also operatively connected to one or more expansion ports 122 via a bus transceiver 402. The one or more expansion ports 122 provide connectivity between the controller 116 and an expansion module (not shown) as described herein.

In operation, the processor 218 loads the programming instructions into the main memory 220 and executes the programming instructions to implement the features of the printer 100 as described herein.

As illustrated, the printer main controller 116 is shown as being electronically connected to the print module 110 and one or more paper trays 108 without any mechanically coupling. The printer main controller can be mounted in a variety of ways and incorporated into various components of either the printer 100 or the game hosting the printer. For example, the printer main controller is attached to and supported by the print module, one or more paper trays, or the host game as required to mechanically integrate the printer into the host game.

Furthermore, as illustrated, the printer main controller 116 includes a processor 218 that operates using programming instructions stored in memory 224 to implement the features of printer 100 as described herein. However, it is to be understood that the functions of printer main controller 116 can also be implemented using dedicated circuits, programmable controllers, general purpose computers or the like either operating alone or in a combination.

FIG. 3 is an illustration of the expansion bays or ports of a modular transaction printer in accordance with an exemplary embodiment of the present invention.

The modular transaction printer 100 contains an open system architecture that allows its functions to be expanded through the installation of expansion modules 500 (of FIG. 5a). These expansion modules can be plugged into the bus expansion port 122 or the printer resources port 124. Further detail on an expansion module is disclosed in FIG. 6a and FIG. 6b as well as throughout this specification.

The main controller 218 includes the processor, memory and logic of the printer 100. The printer resources 302 allows for the complete operation of the printer's 100 engine and facilities or to operate the printer in tandem with the printer's main controller 218.

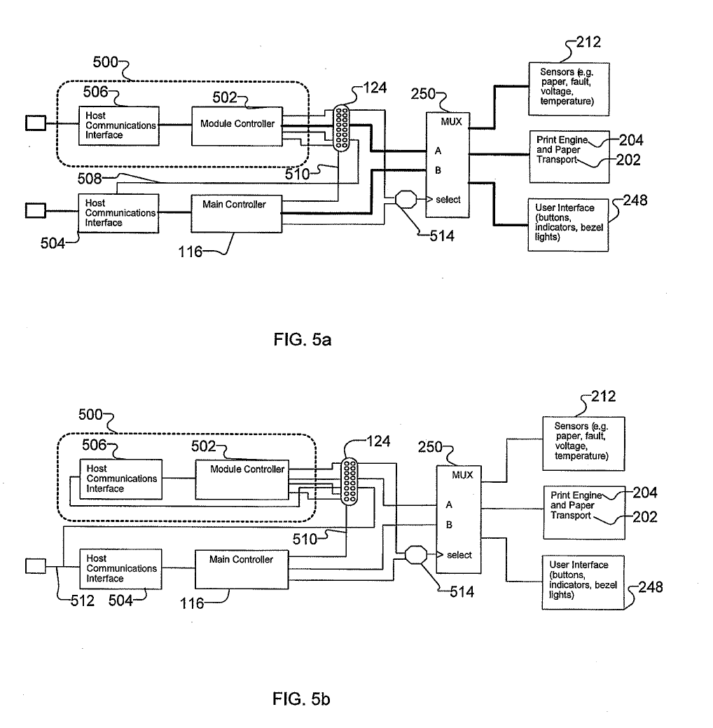

FIG. 4 is an illustration of the expansion bus of a modular transaction printer in accordance with an exemplary embodiment of the present invention.

The modular transaction printer 100 includes an expansion bus 400 in addition to the main controller 218 of the printer where the expansion bus is generic in nature to allow for the future expansion of the printer's main controller functionality. The expansion bus allows co-processing and/or expanded memory to be added to the printer's main controller by using the expansion modules 500 (of FIG. 5a).

The main controller 218 contains processor instructions, encoding algorithms, and logic to monitor and detect whether an expansion module 500 (of FIG. 5a) is connected to the expansion bus port 122 and then subsequently interrogate the makeup of the connected module. Upon interrogation and authentication of the module, the processor code will either: (a) pass control to the connected module, (b) execute code from the connected module, or (c) utilize the memory and/or the contents of the memory in the connected module.

The circuitry of the bus transceiver 402 is designed to ensure proper buffering of the expansion modules' bus 500 (of FIG. 5a) from the processor's bus 222.

Additionally, the main controller 218 code could disable the printer 100 if an unauthorized module 500 (of FIG. 5a) is connected to the bus expansion port 122 as shown and/or the printer resources port 124 (not shown). An unauthorized module is a module not designed or in conformance with the requirements or set up of the printer.

Additionally, the printer 100 could disable itself if any module 500 (of FIG. 5a) is connected 408 to the bus expansion port 122 and/or the printer resources port 124 (not shown); for example, if an unauthorized expansion module is connected.

The dynamic memory 404 includes the heap and variables, among others of and for the printer 100. The static memory 406 includes the code, constants, and data, among others of and for the printer 100. Additional detail on memory is disclosed in FIG. 2.

Referring now to both FIGS. 5a and 5b, FIGS. 5a and 5b are illustrations of expansion bays or ports for accessing printer resources in accordance with exemplary embodiments of the present invention.

A modular transaction printer 100 (of FIG. 1) includes one or more expansion bays or ports to which an expansion module 500 connects or plugs in where one expansion bay or port 122 (of FIG. 1) allows for the future expansion of the printer's main controller 116 functionality and one expansion bay or port 124 is used for the printer resources 302 (of FIG. 3).

The printer 100 (of FIG. 1) has a resources sharing port called the printer resources access port 124. This port allows the sharing of, for example, sensors 212, print engine 204, paper transport 202, and user interface 248, among others. This port allows an expansion module 500, having its own module controller 502, to completely operate the printer's engine and facilities, or to operate the printer in tandem with the printer's main controller 116. The main controller is primarily responsible for interfacing 504 with the game, and the printing of vouchers for the gaming machine.

The module controller 502 is contained with an expansion module 500 and is added into the system by plugging the expansion module into the printer resources access port 124. The module controller can be responsible for printing vouchers and promotional tickets. The module controller typically could connect to a promotional host (not shown) which is responsible for promotional tickets and vouchers, via host communication interface 506.

In the operation of one embodiment, the main controller 116 owns the printer resources 302 by default. The module controller 502 is signaled by the promotional system (via its host communication interface 506) to print a promotional ticket. The module controller also monitors inbound communications 508 from the gaming machine and ensures that when the game requests a voucher to be printed by the main controller, that the printer resources are relinquished to the main controller so that no interruption of voucher printing occurs. Responsibility for printer resource collision avoidance 514 in this scheme lies with the module controller.

In the operation of another embodiment, the main controller 116 and module controller 502 cross signal 510 one another to keep each other informed about the status of print jobs from their respective host communication interfaces 504 and 506. Logic in both processors determines which processor owns the printer resources 302 and cross signaling ensures collision avoidance 514.

As illustrated in FIG. 5b in one embodiment, controllers 218 and 502 share a common physical interface 512. The common physical interface allows for more efficient use of physical resources used to support the controllers 218 and 502.

FIG. 6a is an exploded view of an expansion module for a modular transaction printer in accordance with an exemplary embodiment of the present invention.

An expansion module 500 is a self-contained device that includes any two or more of the following, among others: a circuit board 602, a controller 604, memory 606 containing instructions executable by the controller 604, logic circuitry 600, authentication memory, data or logic, a port connector 608, an enclosure 610a and 610b, a latching mechanism 614 (of FIG. 6b), and user indicators 612.

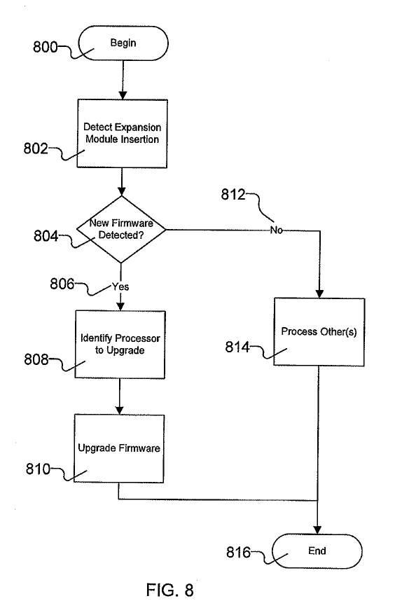

An expansion module 500 can be prepackaged with the necessary data, among others, to perform certain functions, such as among others, promotional printing and/or firmware upgrades as described in FIG. 8. Additionally, an expansion module can provide an interface and connection to different protocols and systems such as described in FIG. 7.

An expansion module 500 allows for the easy in-field upgradeability of the printer 100. An expansion module is hot swappable in that the printer need not be powered down to add or remove an expansion module. The module is easy to install or remove from the printer with a minimum of effort. Either the module or the printer chassis contains a latching mechanism 614 (of FIG. 6b) which ensures that the module stays firmly seated in the expansion bay 122 and/or 124 once installed.

In another embodiment, an expansion module uses one or more securing mechanisms such as a screw to securely attach the module to the printer.

Additionally, an expansion module 500 includes the necessary data and/or logic to identify the expansion module as an authentic module suitable for use in the printer 100. This allows a processor or controller of a modular transaction printer to authenticate an expansion module before allowing the expansion module access to the printer's resources or processor.

FIG. 6b is a partial view of a modular transaction printer and expansion bays or ports and expansion modules in accordance with an exemplary embodiment of the present invention. Each expansion module 500 is plugged 616 into an expansion bay or port 122 and/or 124 of the printer chassis 100 or the mobile module for easy installation using a port connector 608. Additionally, the latching mechanism 614 allows the expansion module to be securely plugged in.

FIG. 7 is a block diagram of a modular transaction printer and expansion modules in accordance with an exemplary embodiment of the present invention.

As illustrated, the printer 100 has the ways and means to allow more expansion modules 500 to be connected to the printer. The means include a mechanical package which allows the modules to be inserted from the exterior of the printer, an electrical interface which allows the modules to communicate with the main body of electronics in the printer, and a latching mechanism 614 to secure the modules to the printer thereby facilitating their easy connect and disconnect from the body of the printer. Each module can contain one or more of the following as well as any or all previously described: memory 606 such as dynamic memory, non-volatile memory, a processor circuitry 604 necessary to accomplish a port or an interface with an outside host device, and a standard bus style interface 608 method. The standard bus style interface allows for interchangeable expansion modules. By using interchangeable expansion modules, a printer can be configured as a base or basic model. Then depending on configuration requirements, the interchangeable modules can be securely attached 616 to the printer.

An expansion module 500 can be prepackaged with the necessary data, among others, to perform certain functions, such as among others, promotional printing and/or firmware upgrades as described in FIG. 8. Additionally, an expansion module can provide an interface and connection to different protocols and systems. Examples of such include Netplex 702, RS232 704, USB GSA 706, USB SPC 708, Ethernet 710, Ethernet S2S 712, Ethernet G2S 714, and Other(s) 716 which include Slot Accounting System (SAS), Promotional System, etc.

In the operation of one embodiment, expansion modules 500 for Netplex 702 and Ethernet S2S 712 are connected to the printer 100. After the printer identifies each module as authentic, an interface and connection can be made to both Netplex and Ethernet S2S for communication and data exchange to and from the printer.

FIG. 8 is a flow chart of a firmware upgrade process using an expansion module in accordance with an exemplary embodiment of the present invention.

An expansion module 500 can include the necessary data and/or logic among others to upgrade the firmware of another processor, such as the main controller 218 or another expansion module.

In this flow chart, the process begins 800 with detecting that an expansion module 500 was inserted 802 to an expansion port 122 and/or 124 of the printer 100. Once detected 804, the expansion module is scanned to detect new firmware for another processor. If new firmware is detected 806, the process continues with identify the processor to upgrade 808 where algorithms and/or security means identify the processor such as the main controller 218 as being the correct processor to upgrade. Once identified, the firmware of the processor is upgraded 810 and the process ends 816.

If new firmware is not detected 812, the process continues with process other(s) 814 where the expansion module 500 includes the means to process other functions, such as promotional printing and/or interfacing and connecting to another port after which the process ends 816.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A modular transaction printer comprising:
a print module;
a main controller coupled to a print module;
a bus expansion port;
a printer resources port;
an expansion module of a first type coupled to the bus expansion port and configured to expand the functionality of the printer's main controller; and
an expansion module of a second type coupled to the printer resources port and configured to share the printer's resources.
